(19) United States
(12) Patent Application Publication
(10) Pub. No.: US 2026/0179281 A1
(43) Pub. Date: Jun. 25, 2026

(54) ELECTRONIC DEVICE AND METHOD OF OPERATION THEREOF

(71) Applicant: Samsung Electronics Co., Ltd., Suwon-si (KR)

(72) Inventors: NURI HAN, Suwon-si (KR); JONGBIN PARK, Suwon-si (KR); JIWON SEO, Suwon-si (KR); JIHYUNG OH, Suwon-si (KR); Jinwoo Lee, Suwon-si (KR); Boram Jeong, Suwon-si (KR); JongHee Ha, Suwon-si (KR); GILHWAN KIM, Suwon-si (KR); JUNGHWAN KIM, Suwon-si (KR); MOONHWAN PARK, Suwon-si (KR); DO-YOUNG SHIN, Suwon-si (KR); YOHWAN JOO, Suwon-si (KR)

(21) Appl. No.: 19/283,733

(22) Filed: Jul. 29, 2025

(30) Foreign Application Priority Data
Dec. 19, 2024 (KR) 10-2024-0191764

(51) Int. Cl. G06T 11/60; G06F 40/117; G06F 40/166; G06Q 10/0631

(52) U.S. Cl. CPC G06T 11/60; G06F 40/117; G06F 40/166; G06Q 10/06316

(57) ABSTRACT

The present disclosure relates to an electronic device comprising a communication circuit, a memory and a processor, wherein the memory stores instructions that, when executed by the processor, cause the electronic device to acquire facility data from a facility via the communication circuit, analyze a cause of failure of the facility based on the facility data, generate guide data identifying actions for resolving the failure of the facility based on the cause of failure, generate multimedia content related to the actions for resolving the failure using the guide data as input data, and output the multimedia content.

### CROSS-REFERENCE TO RELATED APPLICATION

This application claims priority to and the benefit of Korean Patent Application No. 10-2024-0191764 filed with the Korean Intellectual Property Office on Dec. 19, 2024, the entire contents of which are incorporated herein by reference.

### BACKGROUND OF THE DISCLOSURE

### 1. Field

The present disclosure relates to an electronic device and a method of operating the same.

### 2. Description of the Related Art

Semiconductor manufacturing processes require a high degree of precision and stability, and the process facility that supports them consists of complex mechanical, electrical, and chemical systems. Such a facility, if it fails, may result in reduced production efficiency, quality problems, and economic losses.

However, fault diagnosis of process facility mainly relies on the experience of engineers and facility data, and it is often difficult to quickly identify and resolve complex causes of failure. Recently, big data and artificial intelligence (AI) technologies are being utilized for failure analysis, but they may only identify the cause of the failure and do not provide specific guidance necessary for problem solving.

Accordingly, technology to effectively analyze the cause of facility failure and provide users with practical solution guides would be beneficial.

### SUMMARY

The present disclosure attempts to provide an electronic device and an operating method for improving the stability of facility and maximizing production efficiency by quickly recognizing the cause of facility failure and effectively providing guidance to a user to resolve the failure.

An electronic device according to one embodiment comprises a communication circuit, a memory and a processor, wherein the memory stores instructions that, when executed by the processor, cause the electronic device to acquire facility data from a facility via the communication circuit, analyze the facility data to determine a cause of failure of the facility, generate guide data describing a procedure resolving the failure of the facility based on the cause of failure, generate multimedia content using the guide data as input data, and output the multimedia content.

An electronic device according to one embodiment comprises a memory, and a processor, wherein the memory stores instructions that, when executed by the processor, cause the electronic device to acquire user provided data related to a failure of a facility, generate text information corresponding to the user provided, generate guide data detailing how to resolve the failure of the facility based on the text information, generate multimedia content using the guide data as input data, and output the multimedia content.

An electronic device according to one embodiment comprises a communication circuit, a memory storing a first artificial intelligence (AI) model trained to generate text corresponding to input data and a second AI model trained to insert tagging information corresponding to a media type into the input data, and a processor, wherein the memory stores instructions that, when executed by the processor, cause the electronic device to acquire facility data related to a failure of a facility via the communication circuit, acquire user submitted data related to the failure of the facility, generate text information corresponding to the facility data or the user submitted data using the first AI model, generate guide data describing a procedure resolving the failure of the facility based on the text information, insert tagging information corresponding to the media type into the guide data using the second AI model, and generate multimedia content based on the inserted tagging information.

According to the embodiments, the stability of the facility may be improved and production efficiency may be maximized by quickly recognizing the cause of facility failure and effectively providing guidance to the user.

### BRIEF DESCRIPTION OF THE DRAWINGS

FIG. 1 is a block diagram of an electronic device according to one embodiment.

FIG. 2 is a diagram for explaining a method for an electronic device according to one embodiment of the present disclosure to generate and provide a guide related to a failure of a facility.

FIG. 3 is a flowchart illustrating a method of operating an electronic device according to one embodiment.

FIG. 4 is a flowchart illustrating a method of operating an electronic device according to one embodiment.

FIG. 5 is a diagram for explaining a method for an electronic device according to one embodiment of the present disclosure to analyze the cause of a failure of a facility.

FIG. 6 is a diagram illustrating a method for an electronic device according to one embodiment of the present disclosure to generate a query necessary to resolve a cause of a failure of a facility.

FIG. 7 is a diagram for explaining a method for analyzing an action method for resolving a cause of a failure of a facility by an electronic device according to one embodiment.

FIG. 8 is a diagram illustrating a method for an electronic device according to one embodiment of the present disclosure to generate guide data related to a failure of a facility.

FIG. 9 is a diagram illustrating a method for an electronic device to determine guide data according to one embodiment.

FIG. 10 is a diagram illustrating a method for an electronic device according to one embodiment to determine whether necessary tagging information has been inserted into guide data.

FIG. 11 is a diagram for explaining a method for an electronic device according to one embodiment of the present disclosure to generate multimedia content using guide data as input data.

FIG. 12 is a diagram illustrating multimedia content generated by an electronic device according to some embodiments.

FIG. 13 is a diagram illustrating a method for an electronic device according to one embodiment of the present disclosure to generate and provide a guide for resolving a malfunction of a facility based on facility data.

FIG. 14 is a diagram illustrating a method for an electronic device according to one embodiment of the present disclosure to generate and provide a guide for resolving a malfunction of a facility based on a user's voice.

FIG. 15 is a diagram illustrating a method for an electronic device according to one embodiment of the present disclosure to generate and provide a guide for resolving facility failures based on user movements.

FIG. 16 is a diagram illustrating an example of a computer device implementing an electronic device according to one embodiment.

### DETAILED DESCRIPTION

Hereinafter, various embodiments of the present disclosure will be described in detail with reference to the attached drawings so that a person having ordinary skill in the art to which the present disclosure pertains may easily implement the disclosure. The present disclosure may be embodied in many different forms and is not limited to the embodiments described herein. It should be emphasized that the disclosure provides details of alternative examples, but such listing of alternatives is not exhaustive. Furthermore, any consistency of detail between various examples should not be interpreted as requiring such detail. The language of the claims should be referenced in determining the requirements of the invention.

In order to clearly explain the present disclosure, parts that may be unrelated to the inventive concept may be omitted, and the same reference numerals are used for identical or similar components throughout the specification.

In addition, the size and thickness of each component shown in the drawing are arbitrarily shown for convenience of explanation, so the present disclosure is not necessarily limited to what is shown. In the drawings, the thickness of layers, films, panels, regions, etc., are exaggerated for clarity. To clearly represent the various layers and areas in the drawing, the thickness is enlarged and shown. And in the drawing, for convenience of explanation, the thickness of some layers and areas is exaggerated.

It will be understood that when an element such as a layer, film, region, or substrate is referred to as being “on” another element, it may be directly on the other element or intervening elements may also be present. In contrast, when an element is referred to as being “directly on” another element, there are no intervening elements present. Also, being “above” or “on” a reference part means being located above or below the reference part, and does not necessarily mean being located “above” or “on” the opposite direction of gravity.

In addition, unless explicitly described to the contrary, the word “comprise”, and variations such as “comprises” or “comprising”, will be understood to imply the inclusion of stated elements but not the exclusion of any other elements. Throughout the specification, when a component is described as “including” a particular element or group of elements, it is to be understood that the component may be formed of only the element or the group of elements, or the element or group of elements may be combined with additional elements to form the component, unless the context indicates otherwise. The term “consisting of,” on the other hand, indicates that a component is formed only of the element(s) listed.

Additionally, throughout the specification, the phrase “in a plan may indicate the target portion is viewed from above, and the phrase “in a cross section”, may indicate when the target portion is viewed from the side in a cross-section cut vertically.

Additionally, terms such as “. . . part”, “. . . device”, “. . . module”, etc. described in the specification perform at least one function or operation, and may be implemented by hardware or software, or by a combination of hardware and software.

Additionally, a plurality of “. . . modules”, a plurality of “. . . units”, or a plurality of “. . . modules” may be integrated into at least one module and implemented with at least one processor, unless the language explicitly indicates that a “. . . unit”, a “. . . unit”, or a “. . . module” needs to be implemented with specific hardware.

In this specification, “transmitting,” “transmitting,” “providing,” or “receiving” may include not only directly transmitting, transmitting, providing, or receiving, but also indirectly transmitting, transmitting, providing, or receiving via another device or by using a bypass route.

In this specification, expressions described in the singular may be interpreted as singular or plural, unless explicit expressions such as “one” or “singular” are used.

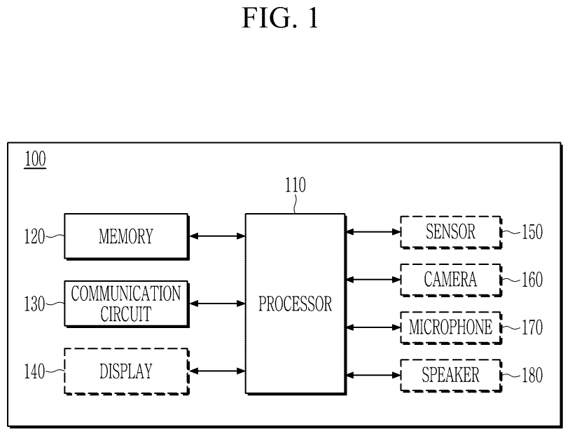

Referring to FIG. 1 below, an electronic device according to one embodiment is described.

An electronic device according to an embodiment may recognize a failure of a facility and provide a guide for resolving the failure in the form of multimedia content. For example, facility failures may be automatically recognized using facility data, or a user's voice or movement may be detected to recognize the user's status related to facility failures. In response to recognizing a fault in the facility, the electronic device may output guidance for resolving the fault in the form of multimedia content (e.g., video, audio, or still images). In the present disclosure, video content may be referred to as a video, and a still image may be referred to as an image.

FIG. 1 is a block diagram of an electronic device according to one embodiment.

Referring to FIG. 1, an electronic device 100 according to one embodiment may comprise at least one processor 110, memory 120, and a communication circuit 130. According to one embodiment, the electronic device 100 may further comprise a display 140, a sensor 150, a camera 160, a microphone 170, and a speaker 180. In some embodiments, the electronic device 100 may omit at least one of the components described above or may additionally comprise other components.

According to one embodiment, the processor 110 may control the overall operation of the electronic device 100. The processor 110 may comprise an accelerator, which is a dedicated circuit for data operations. The accelerator may be a functional block that specializes in performing a specific function of the processor 110. The accelerator may comprise a GPU (Graphics Processing Unit), an NPU (Neural Processing Unit), or a DPU (Data Processing Unit). The GPU may be a functional block that specializes in processing graphic data. The NPU may be a functional block specialized for performing AI computations and inference. The DPU may be a functional block that specializes in data transmission.

According to one embodiment, the processor 110 may execute instructions stored in the memory 120. A collection of instructions may constitute an application stored in the memory 120. The processor 110 may execute the applications stored in memory 120. The processor 110 may cause the electronic device 100 to perform the operations described below by executing instructions stored in the memory 120. The operations described below as being performed by the processor 110 may be performed by the processor 110 and/or at least one other component of the electronic device 100 connected to the processor 110, and thus may be understood to be performed by the electronic device 100.

According to one embodiment, the memory 120 may store data used or received by at least one component of the electronic device 100 (e.g., a processor 110, a communication circuit 130, a sensor 150, a camera 160, or a microphone 170). The memory 120 may store instructions executed by at least one processor 110.

According to one embodiment, the memory 120 may store instructions for executing a method of detecting (or recognizing) a failure of a facility. Additionally, the memory 120 may store instructions for executing a method for resolving a malfunction of the facility. The instructions may be stored in memory 120 as code of a computer program. According to one embodiment, the memory 120 may store data related to the facility. For example, data related to a facility may include information about the facility's properties (e.g., size, location, equipment contained therein, product lines, etc.) or a history of past actions related to facility failures (e.g., equipment replacement, power reset, etc.). However, data related to the facility is not limited to the examples described above and may include various information related to the facility.

According to one embodiment, the memory 120 may store one or more artificial intelligence models (or neural network models) and a training data set. The learning algorithm may include, but is not limited to, algorithms that perform supervised learning, unsupervised learning, semi-supervised learning, or reinforcement learning, for example.

An artificial intelligence model may contain multiple artificial neural network layers. For example, the artificial intelligence model may be one of a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more of the above, but is not limited to the examples described above. The artificial intelligence model may be referred to generically as a neural network in the following description.

According to one embodiment, the one or more artificial intelligence models may include an artificial intelligence model that generates text corresponding to user submitted data such as audio data or image data. For example, an AI model may analyze a user's utterances contained in voice data and generate text corresponding to the user's utterances. Additionally, one or more artificial intelligence models may include an artificial intelligence model that generates text corresponding to image data. For example, an AI model may analyze image data or a user's movements contained in image data and generate text corresponding to the user's movements. Additionally, one or more artificial intelligence models may include an artificial intelligence model that inserts tagging information into input data. For example, the AI model may analyze input data, which may consist of text, and automatically generate and insert tags related to the content. The tags may refer to other media content related to the input data. For example, the tag may be a link to the other media content.

According to one embodiment, the training data set may be a data set used to train an artificial intelligence model. For example, a training data set may contain documents from the semiconductor domain. Here, a document in the semiconductor domain may indicate a document related to the semiconductor field. For example, documents related to the semiconductor field may include, but are not limited to, technical documents, research papers, patent documents, industry reports, standards documents, and educational materials.

According to one embodiment, the memory 120 may store data transmitted and received through the communication circuit 130. For example, the memory 120 may store facility data received through the communication circuit 130. According to one embodiment, the facility data may be obtained from an external electronic device (e.g., a cloud server, web storage) or an external storage device (e.g., an external database, an external memory card) via a communication circuit 130 and stored in the memory 120.

According to one embodiment, the memory 120 may store data transmitted and received through the sensor 150. For example, the memory 120 may store sensing data received through the sensor 150. For example, sensing data may detect a user's movements and include electrical signals or data values corresponding to the detected state.

According to one embodiment, the memory 120 may store image data output through the display 140. According to one embodiment, the memory 120 may store image data acquired through the camera 160. For example, the image data may include at least one of still image data or video data.

According to one embodiment, the memory 120 may store various media data, such as voice data obtained from a microphone 170 and audio data output through a speaker 180.

The memory 120 may be non-transitory storage medium that does not include transitory signals. In some embodiments, the memory 120 may be implemented as a non-volatile memory, such as Read-Only Memory (ROM), Magnetic RAM (MRAM), Spin-Transfer Torque MRAM (SpinTransfer Torque MRAM), Conductive bridging RAM (CBRAM), Ferroelectric RAM (FeRAM), Phase RAM (PRAM), Resistive RAM, etc. However, it is not limited to this.

In other embodiments, the memory 120 may be implemented as a volatile memory, such as dynamic random-access memory (DRAM), synchronous DRAM (SDRAM), double data rate SDRAM (DDR SDRAM), low power double data rate SDRAM (LPDDR SDRAM), graphics double data rate SDRAM (GDDR SDRAM), DDR2 SDRAM, DDR3 SDRAM, DDR4 SDRAM, DDR5 SDRAM, and the like. However, it is not limited to this.

According to one embodiment, the communication circuit 130 may support establishment of a wired or wireless communication channel between the electronic device 100 and an external electronic device, and performance of communication through the established communication channel. For example, the processor 110 may obtain facility data from a cloud server, web storage, or external storage device (e.g., external database, external memory card) via the communication circuit 130.

For example, facility data may include facility text log data or facility time series data. In the present disclosure, facility text log data may mean data in text format that records an operating status or event in a system, application, network facility, etc., and facility time series data may mean data measured from a sensor included in the facility, which may be measured at regular intervals, and recorded in chronological order.

According to one embodiment, the communication circuit 130 may include a wireless communication module (e.g., a cellular communication module, a short-range wireless communication module, or a global navigation satellite system (GNSS) communication module) or a wired communication module (e.g., a local area network (LAN) communication module, or a power line communication module).

According to one embodiment, the processor 110 may communicate with an external electronic device via a first network (e.g., a short-range communication network such as Bluetooth, WiFi direct, or infrared data association (IrDA)) or a second network (e.g., a long-range communication network such as a cellular network, the Internet, or a computer network (e.g., a LAN or WAN)) using the communication circuit 130. The various types of communication circuit 130 described above may be implemented in one chip or in separate chips.

According to one embodiment, the display 140 may display information processed on the display 140 under the control of the processor 110. For example, the display 140 may display various contents (e.g., text, images, videos, icons, and/or symbols). According to one embodiment, the display 140 may include a liquid crystal display (LCD), a light emitting diode (LED) display, or an organic light emitting diode (OLED) display.

According to one embodiment, the display 140 may include, for example, a touch screen and may receive touch, gesture, proximity, or hovering input using an electronic pen or a part of the user's body. In this case, the display 140 may also be used as an input device, but is not limited thereto. In some embodiments, the electronic device 100 may comprise a separate input device.

According to one embodiment, the display 140 may visually provide various information to a user of the electronic device 100. According to one embodiment, the display 140 may display multimedia content in response to the generation of multimedia content, which will be described later.

According to one embodiment, the display 140 may display data processed by the processor 110. According to one embodiment, the display 140 may display at least one of video data or still image data included in multimedia content described below.

According to one embodiment, the display 140 may display a graphical user interface (GUI) that represents the analysis results. For example, the display 140 may sort (or list) reference data in order of high similarity based on the results of a similarity analysis between facility data or a query to be described later and reference data in a database stored in the memory 120.

According to one embodiment, the sensor 150 may detect an external environmental condition (e.g., user movement) and generate an electrical signal or data value corresponding to the detected condition. For example, the sensor 150 may include a gesture sensor, a gyro sensor, a pressure sensor, a magnetic sensor, an acceleration sensor, a grip sensor, a proximity sensor, a color sensor, an IR (infrared) sensor, a biometric sensor, a temperature sensor, a humidity sensor, or a light sensor.

According to one embodiment, the camera 160 may capture an object (e.g., a user) to obtain image data. For example, the image data may include at least one of still image data or video data. According to one embodiment, the camera 160 may include one or more lenses, image sensors, image signal processors, or flashes.

According to one embodiment, the microphone 170 may acquire an audio signal (e.g., a voice signal). For example, the electronic device 100 may comprise one or more microphones. According to one embodiment, the microphone 170 may obtain a voice signal corresponding to the user's utterances.

According to one embodiment, the speaker 180 may output an audio signal. For example, the electronic device 100 may comprise one or more speakers. According to one embodiment, the speaker 180 may convert an electrical signal into sound. According to one embodiment, the speaker 180 may output multimedia content in response to the generation of multimedia content, which will be described later. According to one embodiment, the speaker 180 may output audio data included in multimedia content to be described later.

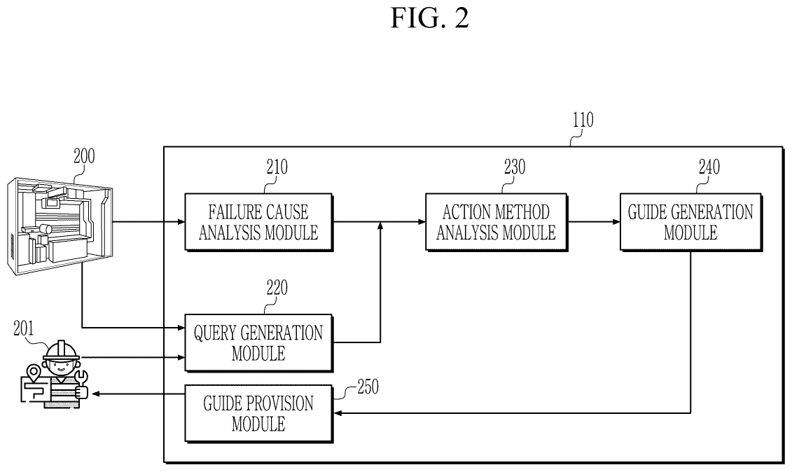

FIG. 2 is a diagram for explaining a method for an electronic device according to one embodiment of the present disclosure to generate and provide a guide related to a failure of a facility.

Referring to FIG. 2, an electronic device (e.g., the electronic device 100 of FIG. 1) or a processor (e.g., the processor 110 of FIG. 1) according to one embodiment may include a failure cause analysis module 210, a query generation module 220, an action method analysis module 230, a guide generation module 240, and a guide provision module 250. In some embodiments, the processor 110 may omit at least one of the components described above, combine two or more of the components listed above, or may additionally comprise other components.

According to one embodiment, the failure cause analysis module 210, the query generation module 220, the action method analysis module 230, the guide generation module 240, and the guide provision module 250 may be a detailed representation of functions executed by the processor 110. The operations of the failure cause analysis module 210, the query generation module 220, the action method analysis module 230, the guide generation module 240, and the guide provision module 250 described below may be operations performed by the electronic device 100 by executing instructions stored in the memory 120 by the processor 110.

According to one embodiment, the failure cause analysis module 210 may obtain facility text log data from the facility 200. For example, the failure cause analysis module 210 may receive facility text log data from the facility 200 through a communication circuit (e.g., the communication circuit 130 of FIG. 1). Here, facility text log data may refer to data in text format that records operating status or events in the facility.

According to one embodiment, the failure cause analysis module 210 may configure facility text log data obtained from the facility 200 as nodes of a network graph. An example of the operation of the failure cause analysis module 210 follows.

First, the failure cause analysis module 210 may separate facility text log data into sentence units or event units. The failure cause analysis module 210 may apply natural language processing techniques to extract main keywords from the text log data. For example, the failure cause analysis module 210 may extract keywords from each log sentence in the text log data. The failure cause analysis module 210 may define the extracted keywords as nodes of the neural network.

Next, the failure cause analysis module 210 creates a connection relationship between nodes based on time sequence and semantic association. For example, the failure cause analysis module 210 may set the causal relationship between a log entry (e.g., a keyword represented as a node) that occurred first and a log entry that occurred later as an edge (or edge line) (e.g., an edge between the nodes). Additionally, for example, the failure cause analysis module 210 may connect interrelated logs (e.g., nodes representing the logs) to edges using a machine learning-based relationship extraction algorithm. The failure cause analysis module 210 may assign a weight value to each edge to represent the strength of the relationships. For example, the weight value may be based on occurrence frequencies, correlation coefficients, logarithmic time intervals, etc.

Next, the failure cause analysis module 210 may construct a network graph based on the generated nodes and edges. The failure cause analysis module 210 determines (or selects) a centrality index used for determining a failure cause of the facility 200, and may determine the failure cause of the facility 200 based on the centrality index. The centrality index may be calculated using commonly available algorithms such as degree centrality, closeness centrality, betweenness centrality, or eigenvector centrality, but embodiments are not limited thereto.

According to one embodiment, the failure cause analysis module 210 may obtain facility time series data from the facility 200. For example, the failure cause analysis module 210 may receive facility time series data from the facility 200 through a communication circuit (e.g., the communication circuit 130 of FIG. 1). Here, facility time series data may be measurement data, which may represent measurements taken at regular intervals from sensors included in the facility and recorded. The measurement data may be recorded in chronological order. For example, facility time series data may include physical variables such as temperature, pressure, vibration, and flow rate.

According to one embodiment, the failure cause analysis module 210 may calculate statistics (e.g., std, avg, dispersion) for facility time series data. The failure cause analysis module 210 may sort the sensor list in order of greatest variability based on calculated statistics.

Next, the failure cause analysis module 210 may search sensor failure history data stored in the database. For example, sensor failure history data may include information such as a sensor ID, failure occurrence statistics, failure cause codes, etc.

According to one embodiment, the failure cause analysis module 210 may calculate similarity of a current failure and a past failure by comparing statistics of facility time series data with statistics of sensor failure history data. The failure cause analysis module 210 may determine the cause of a failure of the facility based on the calculated similarity. For example, if a current failure and a past failure have a high similarity, it may indicate that the cause of failure may be the same or similar.

According to one embodiment, the failure cause analysis module 210 may comprehensively determine the failure causes of the facility by integrating a determination of failure causes based on facility text log data and a determination of failure causes based on facility time-series data, thereby determining the final failure cause of the facility. The final failure cause of the facility may be output by the failure cause analysis module as a failure analysis result.

According to one embodiment, the query generation module 220 may obtain facility text log data from the facility 200. For example, the query generation module 220 may receive facility text log data from the facility 200 via a communication circuit (e.g., the communication circuit 130 of FIG. 1). An example of the operation of the query generation module 220 follows.

First, the query generation module 220 may sort the facility text log data in order of latest date. For example, the query generation module 220 may select facility text log data from the most recent data to a certain time range or limited quantity of data. Next, the query generation module 220 may generate a query for querying the failure analysis results of the facility status based on the facility text log data.

According to one embodiment, the query generation module 220 may obtain voice data input from a user 201. According to one embodiment, the query generation module 220 may identify the user's state (or intention) from the input voice data. The query generation module 220 may generate a query related to an activity required by the user 201 (e.g., an activity associated with the input voice data) in text form in response to acquiring voice data of the user 201.

The query generation module 220 may generate text information corresponding to the voice data using an artificial intelligence model. For example, the query generation module 220 may analyze the user's utterances included in the voice data using an artificial intelligence model and generate text information corresponding to the user's utterances. The query generation module may generate text information that is a transcription of the user's utterances and/or the query generation module may determine keywords based on the user's utterances, which may include terms and phrases related to the user's utterances but not spoken by the user.

According to one embodiment, the query generation module 220 may obtain image data taken by a user 201. According to one embodiment, the query generation module 220 may identify the user's state (or intention) from the input image data. For example, the query generation module 220 may recognize a piece of equipment, a procedure being performed, or a type of failure based on image data submitted by a user. The query generation module 220 may generate a query related to an activity to be performed by the user 201 in text form in response to obtaining image data of the user 201.

The query generation module 220 may generate text information corresponding to the image data using an artificial intelligence model. For example, the query generation module 220 may analyze movements included in the image data based on an artificial intelligence model and generate text information corresponding to the movements. The movements may include a movement of the user or a movement of an object the user is taking an image of.

According to one embodiment, the action method analysis module 230 may obtain the analyzed failure cause from the failure cause analysis module 210. According to one embodiment, the action method analysis module 230 may obtain a query generated by the query generation module 220. According to one embodiment, the action method analysis module 230 may determine an action method for resolving a failure of the facility based on the analyzed failure cause and/or generated query. An example of the operation of the action method analysis module 230 follows.

First, the action method analysis module 230 may generate a prompt corresponding to the cause of the failure and/or the query. For example, the prompt may include keywords associated with a failure analysis result.

According to one embodiment, the action method analysis module 230 may utilize the prompt to discover information related to the failure analysis result. For example, the action method analysis module 230 may collect information related to the failure analysis results such as a failure cause code, related sensor information, and a failure cause description from a prompt corresponding to a failure cause. Additionally, for example, the action method analysis module 230 may utilize a prompt based on a natural language-based request or query generated by the query generation module 220 to discover information related to the failure analysis result.

For example, the action method analysis module 230 may retrieve reference data based on the prompt. For example, reference data may include technical documentation related to the facility. Reference data may be stored in memory (e.g., memory 120), but is not limited thereto. The reference data may be part of a collection of data that may have its context indexed. The action method analysis module 230 may search the collection of data using the prompt to retrieve the reference data. For example, reference data may be obtained from an external electronic device (e.g., cloud server, web storage) or an external storage device (e.g., external database, external memory card).

According to one embodiment, the action method analysis module 230 may analyze the similarity between the prompt and the reference data. For example, the action method analysis module 230 may calculate the cosine similarity between the prompt and the reference data.

For example, the action method analysis module 230 may extract a first feature vector from the prompt, extract a second feature vector from the reference data, and calculate the cosine similarity between the first feature vector and the second feature vector.

According to one embodiment, the action method analysis module 230 may sort (or list) reference data in descending order of similarity based on the similarity calculation result. For example, the action method analysis module 230 may obtain a plurality of references which may then be sorted according to the similarity calculation result.

Next, the action method analysis module 230 may generate guide data for resolving facility failures based on the reference data, which may include references sorted according to similarity. For example, the guide data may contain text based on a similar reference in the reference data.

According to one embodiment, the guide generation module 240 may generate an optimal guide based on guide prompts selected from a prompt lookup table. For example, the guide generation module 240 may select a group of prompt candidates using a prompt lookup table. For example, a set of prompt candidates may contain more than two prompts. Here, the prompt lookup table may be a structured data repository that includes predefined prompts manually registered by a system administrator or dynamically generated from the action method analysis module 230. The prompt lookup table may be indexed by failure cause codes, facility status tags, or event identifiers, and configured to quickly retrieve relevant status descriptions, action methods, or query sentences corresponding to a given keyword. To select prompt candidates, the guide generation module 240 may extract one or more keywords from the guide data, for example, using a rule-based keyword extraction logic or a keyword classification model. Based on the extracted keywords, the guide generation module 240 may query the prompt lookup table to retrieve a group of prompt candidates. The selection may be further refined based on relevance scores, semantic similarity, or confidence metrics computed between the extracted keywords and the metadata associated with each prompt.

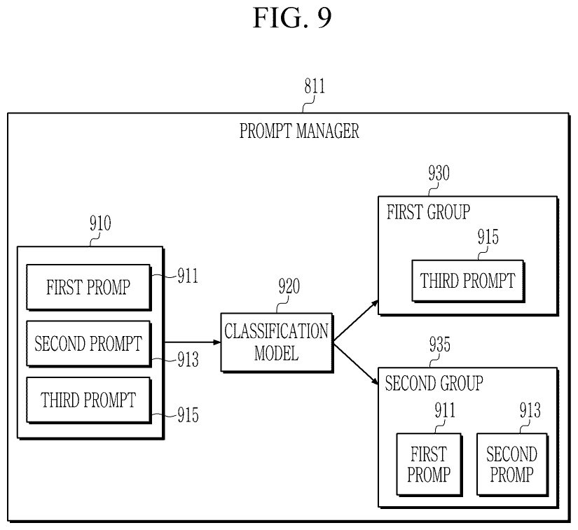

Thereafter, the guide generation module 240 may determine the optimal prompt using the prompt classification model. For example, a prompt classification model may classify a set of prompt candidates into multiple groups and determine a prompt in one of those groups as the optimal prompt. Specific details regarding how the guide generation module 240 determines the optimal prompt are described below with reference to FIG. 9.

According to one embodiment, the guide generation module 240 may generate multimedia content based on the optimal prompt and the guide data. For example, the guide generation module 240 may generate multimedia content including at least one of video data, audio data, or still image data based on at least a portion of text included in the guide data received from the action method analysis module 230.

For example, the guide generation module 240 may insert tagging information corresponding to at least one of a video, audio, or still image into at least some of the text included in the guide data (e.g., the tagging information may identify a particular video, audio, or still image or indicate to generate video, audio, or a still image). Next, the guide generation module 240 may generate multimedia content including video data, audio data, or still image data according to the tagging information. At this time, the guide generation module 240 may generate multimedia content using an artificial intelligence model. For example, the AI model may analyze input data consisting of text and automatically tag media such as video, still images, and audio related to the content.

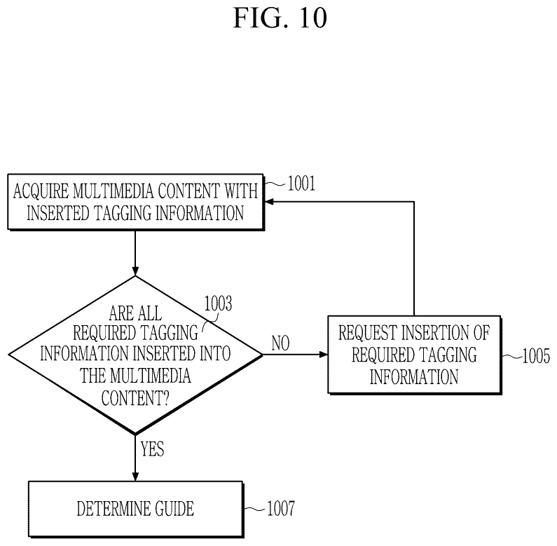

According to one embodiment, the guide generation module 240 may check (or verify) whether all data required for the multimedia content is included. Specific details regarding the method by which the guide generation module 240 checks whether all data required for multimedia content is included will be described later with reference to FIG. 10.

According to one embodiment, the guide provision module 250 may obtain multimedia content generated from the guide generation module 240. According to one embodiment, the guide provision module 250 may output multimedia content in various forms based on the type of multimedia content. For example, the guide provision module 250 may output image data through a display (e.g., display 140 of FIG. 1) in response to determining that multimedia content includes image data. For example, the image data may include at least one of still image data or video data.

According to one embodiment, the guide provision module 250 may output audio data through a speaker (e.g., speaker 180 of FIG. 1) in response to determining that the multimedia content includes audio data.

Additionally, although not shown, the guide provision module 250 may transmit multimedia content to at least one user device via the communication circuit 130. The user device may be a device associated with the user or that the user is currently wearing. For example, the user device may include, but is not limited to, at least one of a smart phone, a smart watch, or a Bluetooth earphone. At least one user device may include various types of devices capable of communicating with the electronic device 100.

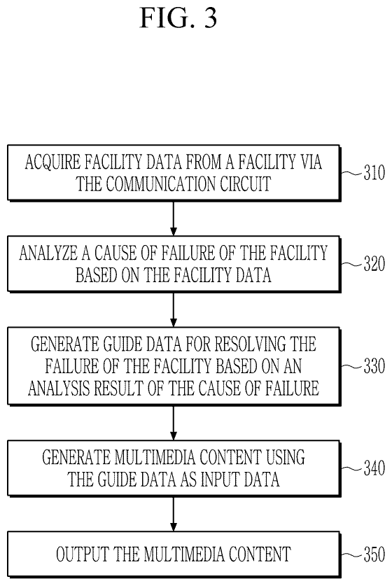

FIG. 3 is a flowchart illustrating a method of operating an electronic device according to one embodiment. The operations described below may be performed by the electronic device 100 of FIG. 1.

FIG. 3 is a flowchart illustrating a method in which an electronic device according to one embodiment analyzes a cause of a failure of facility based on facility data and generates a guide for resolving a failure of the facility.

The operations in FIG. 3 may be performed sequentially, but are not necessarily performed sequentially. For example, the order of the operations may be changed, and at least two operations may be performed in parallel. In some embodiments, some of the operations illustrated in FIG. 3 may be omitted, some operations may be combined, the order of some operations may be changed, or other operations may be added. In the following description of FIG. 3, a description of features that would be duplicative of the previously described features may be simplified or omitted with the understanding that the previous description may be applicable.

Referring to FIG. 3, in operation 310, an electronic device (e.g., electronic device 100 of FIG. 1) according to one embodiment may obtain facility data from a facility (e.g., facility 200 of FIG. 2) through a communication circuit (e.g., communication circuit 130 of FIG. 1).

According to one embodiment, the electronic device 100 may obtain facility text log data from the facility 200. For example, the electronic device 100 may receive facility text log data from the facility 200 via the communication circuit 130. According to one embodiment, the electronic device 100 may obtain facility time series data from the facility 200. For example, the electronic device 100 may receive facility time series data from the facility 200 via the communication circuit 130.

In operation 320, an electronic device 100 according to one embodiment may analyze a cause of a failure of a facility based on facility data (e.g., facility text log data and/or facility time series data).

According to one embodiment, the electronic device 100 may configure the facility text log data obtained from the facility 200 as a node of a network graph. For example, the electronic device 100 may create a connection relationship between nodes based on an association. For example, the electronic device 100 may connect similar logs to edges using a machine learning-based relationship extraction algorithm. Next, the electronic device 100 may determine (or select) a centrality index required for analyzing the cause of a failure of the facility 200, and analyze the cause of a failure of the facility 200 based on the determined centrality index.

According to one embodiment, the electronic device 100 may calculate statistics (e.g., std, avg, dispersion) for the facility time series data. The electronic device 100 may sort a sensor list, which includes sensors associated with the time series data, in order of greatest variability based on the calculated statistics. Next, the electronic device 100 may query sensor failure history data stored in the database.

According to one embodiment, the electronic device 100 may calculate similarity by comparing statistics of facility time series data with statistics of sensor failure history data. The electronic device 100 may analyze the cause of a failure of the facility based on the calculated similarity.

According to one embodiment, the electronic device 100 may comprehensively analyze the failure causes of the facility by integrating the failure causes analyzed based on facility text log data and those analyzed based on facility time-series data, thereby determining the final failure cause of the facility.

In operation 330, the electronic device 100 according to one embodiment may generate guide data for resolving the analyzed cause of the failure.

According to one embodiment, the electronic device 100 may automatically generate a prompt based on the analyzed cause of the failure, as indicated by the final failure cause determined in operation 320. According to one embodiment, the electronic device 100 may analyze the generated prompt. For example, the electronic device 100 may collect analysis results such as a failure cause code, related sensor information, and a failure cause description from a prompt corresponding to the failure cause.

According to one embodiment, the electronic device 100 may determine how to retrieve reference data based on the results of analyzing the prompt (e.g., may determine relevant reference data and keywords). For example, reference data may include technical documentation related to the facility. According to one embodiment, the electronic device 100 may retrieve reference data based on a method of retrieving the reference data.

According to one embodiment, the electronic device 100 may analyze the similarity between the prompt and the reference data. For example, the electronic device 100 may calculate the cosine similarity between the prompt and the reference data.

According to one embodiment, the electronic device 100 may sort (or list) reference data in descending order of similarity based on the similarity calculation result. Next, guide data for resolving facility failures may be generated based on the reference data. For example, guide data may contain text.

In operation 340, an electronic device 100 according to one embodiment may generate multimedia content using guide data as input data.

According to one embodiment, the electronic device 100 may generate multimedia content including at least one of video data, audio data, or still image data based on at least some text included in the guide data.

According to one embodiment, the electronic device 100 may insert tagging information corresponding to at least one of a video, audio, or still image into at least some of the text included in the guide data. Next, the electronic device 100 may generate multimedia content including video data, audio data, or still image data according to the tagging information. At this time, the electronic device 100 may generate multimedia content using an artificial intelligence model. For example, the AI model may analyze input data consisting of text and automatically tag media such as video, still images, and audio related to the content.

In operation 350, an electronic device 100 according to one embodiment may output multimedia content.

According to one embodiment, the electronic device 100 may output multimedia content in various forms based on the type of multimedia content. For example, the electronic device 100 may output image data through a display (e.g., display 140 of FIG. 1) in response to determining that the multimedia content includes still image data or video data.

According to one embodiment, the electronic device 100 may output audio data through a speaker (e.g., speaker 180 of FIG. 1) in response to determining that multimedia content includes audio data.

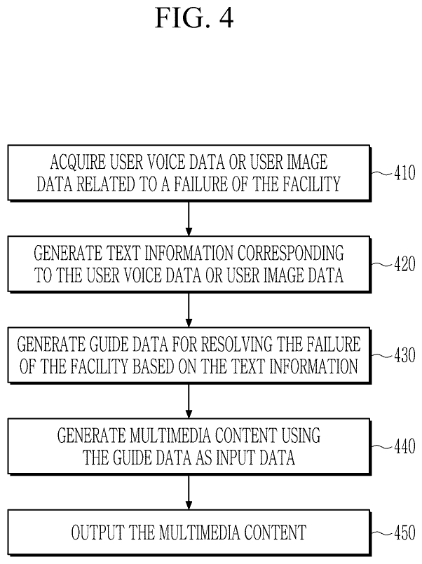

FIG. 4 is a flowchart illustrating a method of operating an electronic device according to one embodiment. The operations described below may be performed by the electronic device 100 of FIG. 1.

For example, FIG. 4 is a flowchart illustrating a method by which an electronic device according to one embodiment generates a guide for resolving facility failures based on interactions with a user.

The operations in FIG. 4 may be performed sequentially, but are not necessarily performed sequentially. For example, the order of the operations may be changed, and at least two operations may be performed in parallel. In some embodiments, some of the operations illustrated in FIG. 4 may be omitted, some operations may be combined, the order of some operations may be changed, or other operations may be added. In the following description of FIG. 4, a description of features that would be duplicative of the previously described features may be simplified or omitted with the understanding that the previous description may be applicable.

Referring to FIG. 4, in operation 410, an electronic device (e.g., the electronic device 100 of FIG. 1) according to one embodiment may obtain user voice data or user image data related to a failure of the facility.

According to one embodiment, the electronic device 100 may obtain voice data from a user (e.g., user 201 of FIG. 2). For example, the electronic device 100 may acquire a voice corresponding to the user's utterances through a microphone (e.g., the microphone 170 of FIG. 1). Additionally, for example, the electronic device 100 may detect the user's voice through at least one sensor (e.g., sensor 150 of FIG. 1).

According to one embodiment, the electronic device 100 may identify the voice of the user 201 from voice data obtained from a microphone 170 or a sensor 150. For example, the electronic device 100 may identify a user based on the voice data.

According to one embodiment, the electronic device 100 may obtain image data taken by a user (e.g., the user 201 of FIG. 2). For example, the electronic device 100 may obtain image data a user captured through a camera (e.g., camera 160 of FIG. 1). For example, the image data may include at least one of still image data or video data. Additionally, for example, the electronic device 100 may detect an objects movement or the user's movement through at least one sensor (e.g., sensor 150 of FIG. 1).

According to one embodiment, the electronic device 100 may identify the actions of the user 201 from image data acquired from a camera 160 or from data acquired from a sensor 150.

In operation 420, the electronic device 100 according to one embodiment may generate text information corresponding to the user's voice data or the user's image data. For example, the text information may include a keyword, a category, or other information about the user, the user's actions, or context of the user.

According to one embodiment, the electronic device 100 may, in response to identifying the voice of the user 201 from the voice data, generate a query in text form related to an activity desired by the user 201, which may be expressed in the user's voice data or the user's image data. At this time, the electronic device 100 may generate text information corresponding to voice data using an artificial intelligence model. In other words, the electronic device 100 may analyze the user's utterances included in the voice data using an artificial intelligence model and generate text information corresponding to the user's utterances.

According to one embodiment, the electronic device 100 may, in response to identifying an action of the user 201 from image data or sensing data, generate a query in text form related to an activity desired by the user 201. At this time, the electronic device 100 may generate text information corresponding to the user's movements using an artificial intelligence model. For example, the text information generated by the electronic device 100 may be structured in the form of a query.

Accordingly, in the present disclosure, the text information generated in operation 420 may be referred to as a query. For example, text information generated based on voice data, image data, or sensing data may be referred to as a query.

In operation 430, an electronic device 100 according to one embodiment may generate guide data for resolving a failure of the facility based on the text information (e.g., the query).

According to one embodiment, the electronic device 100 may automatically generate a prompt based on text information. According to one embodiment, the electronic device 100 may analyze the generated prompt. For example, the electronic device 100 may analyze a natural language-based request or query contained in a prompt.

According to one embodiment, the electronic device 100 may determine how to retrieve reference data based on the results of analyzing the prompt. For example, reference data may include technical documentation related to the facility. According to one embodiment, the electronic device 100 may retrieve reference data based on a method of retrieving the reference data.

According to one embodiment, the electronic device 100 may analyze the similarity between the prompt and the reference data. For example, the electronic device 100 may calculate the cosine similarity between the prompt and the reference data.

According to one embodiment, the electronic device 100 may sort (or list) reference data in descending order of similarity based on the similarity calculation result. Next, guide data may be generated to resolve facility failures based on reference data. For example, guide data may contain text.

In operation 440, an electronic device 100 according to one embodiment may generate multimedia content using guide data as input data.

According to one embodiment, the electronic device 100 may generate multimedia content including at least one of video data, audio data, or still image data based on at least some text included in the guide data.

Specific details regarding the method of generating multimedia content that would be duplicative of the previously described details may be simplified or omitted with the understanding that the previous description with reference to operation 340 of FIG. 3 may be applicable.

In operation 450, an electronic device 100 according to one embodiment may output multimedia content.

According to one embodiment, the electronic device 100 may output multimedia content in various forms based on the type of multimedia content.

Specific details regarding the method of outputting multimedia content that would be duplicative of the previously described details may be simplified or omitted with the understanding that the previous description of operation 350 of FIG. 3 may be applicable.

According to one embodiment, the electronic device 100 may receive the user's voice data or the user's image data while outputting multimedia content. According to one embodiment, the electronic device 100 may output a guide for the next action in the form of multimedia content based on the user's voice data or user image data. Accordingly, the electronic device 100 according to the present disclosure may provide continuous guidance for resolving the cause of a failure of the facility.

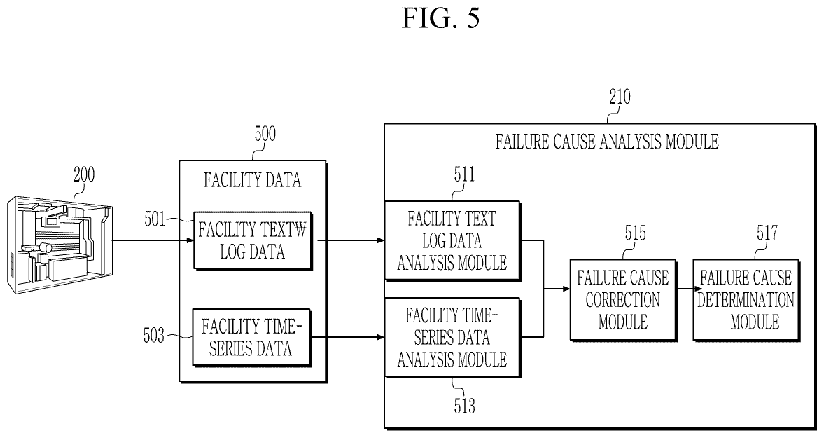

FIG. 5 is a diagram for explaining a method for an electronic device according to one embodiment of the present disclosure to analyze the cause of a failure of a facility.

Referring to FIG. 5, a failure cause analysis module 210 according to one embodiment may include a facility text log data analysis module 511, a facility time-series data analysis module 513, a failure cause correction module 515, and a failure cause determination module 517. In some embodiments, the failure cause analysis module 210 may omit at least one of the components described above or may additionally comprise other components.

According to one embodiment, the facility text log data analysis module 511, the facility time-series data analysis module 513, the failure cause correction module 515, and the failure cause determination module 517 may be functions executed by the processor 110. The operations of the facility text log data analysis module 511, the facility time-series data analysis module 513, the failure cause correction module 515, and the failure cause determination module 517 described below may be operations performed by the electronic device 100 by executing instructions stored in the memory 120 by the processor 110.

Regarding the operation of each component of the failure cause analysis module 210, a description of content that would be duplicative or overlap with the above-described content may be simplified or omitted with the understanding the preceding description is applicable.

According to one embodiment, the failure cause analysis module 210 may obtain facility data 500 from the facility 200. For example, facility data 500 may include facility text log data 501 and facility time series data 503.

According to one embodiment, the facility text log data analysis module 511 may obtain and analyze facility text log data 501. The facility text log data analysis module 511 creates a connection relationship between nodes based on the correlation between logs of facility text log data 501. For example, the facility text log data analysis module 511 may connect similar logs to each other as edges (or edges) in a network graph. The facility text log data analysis module 511 may determine a centrality index required for analyzing the cause of a failure of the facility 200 and analyze the cause code of the failure of the facility 200 based on the determined centrality index.

According to one embodiment, the facility time-series data analysis module 513 may obtain facility time series data 503. For example, the facility time-series data analysis module 513 may collect facility time series data 503 with high statistical volatility. For example, statistics may include the mean (avg), standard deviation (std), dispersion, coefficient of variation (CV) of sensor values, etc. According to one embodiment, the facility time-series data analysis module 513 may analyze the cause of facility failure by comparing statistics of facility time series data with statistics of sensor failure history data.

According to one embodiment, the failure cause correction module 515 may correct the failure cause analysis results obtained from the facility text log data analysis module 511 and the facility time-series data analysis module 513.

According to one embodiment, the failure cause determination module 517 may finally determine the failure cause based on the result corrected by the failure cause correction module 515.

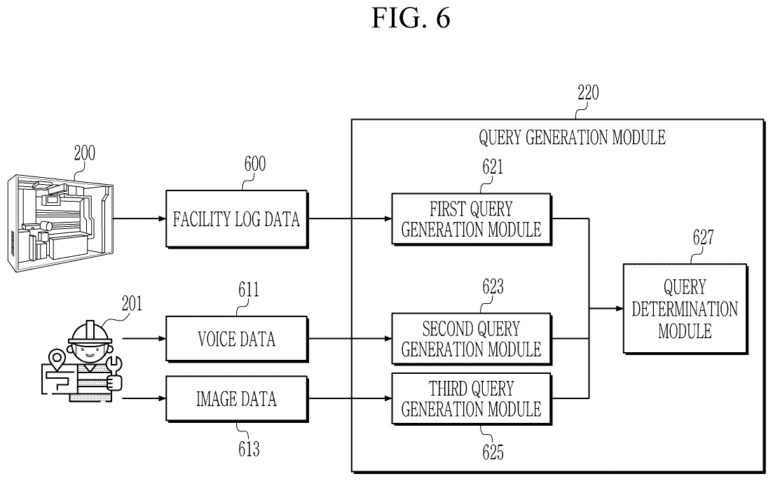

FIG. 6 is a diagram illustrating a method for an electronic device according to one embodiment of the present disclosure to generate a query necessary to resolve a cause of a failure of a facility.

Referring to FIG. 6, a query generation module 220 according to one embodiment may include a first query generation module 621, a second query generation module 623, a third query generation module 625, and a query determination module 627. In some embodiments, the query generation module 220 may omit at least one of the components described above or may additionally comprise other components.

According to one embodiment, the first query generation module 621, the second query generation module 623, the third query generation module 625, and the query determination module 627 may be segmented representations of functions executed by the processor 110. The operations of the first query generation module 621, the second query generation module 623, the third query generation module 625, and the query determination module 627 below may be operations performed by the electronic device 100 by executing instructions stored in the memory 120 by the processor 110.

Regarding the operation of each component of the query generation module 220, a description of content that that would be duplicative of the previously described details may be simplified or omitted with the understanding that the previous description is applicable.

According to one embodiment, the query generation module 220 may obtain facility log data 600 from the facility 200. Here, the facility log data 600 may be understood as having the same concept as the facility text log data 501 described above with reference to FIG. 5.

According to one embodiment, the first query generation module 621 may generate the first query based on the facility log data 600. The first query generation module 621 may sort the facility log data 600 in order of the latest and generate a query for querying the analysis results of the facility status based on the facility log data 600.

According to one embodiment, the second query generation module 623 may obtain voice data 611 input from a user 201. The second query generation module 623 may generate a query related to an activity to be performed by the user 201 in text form in response to obtaining voice data 611 of the user 201. At this time, the second query generation module 623 may generate text information corresponding to voice data 611 using an artificial intelligence model.

According to one embodiment, the third query generation module 625 may obtain image data 613 taken by the user 201. The third query generation module 625 may generate a query related to an activity of the user 201 in text form in response to obtaining image data 613 of the user 201. At this time, the third query generation module 625 may generate text information corresponding to the image data 613 using an artificial intelligence model.

According to one embodiment, the query determination module 627 may determine a query necessary to resolve a malfunction of the facility based on text information generated by the first query generation module 621, the second query generation module 623, and the third query generation module 625.

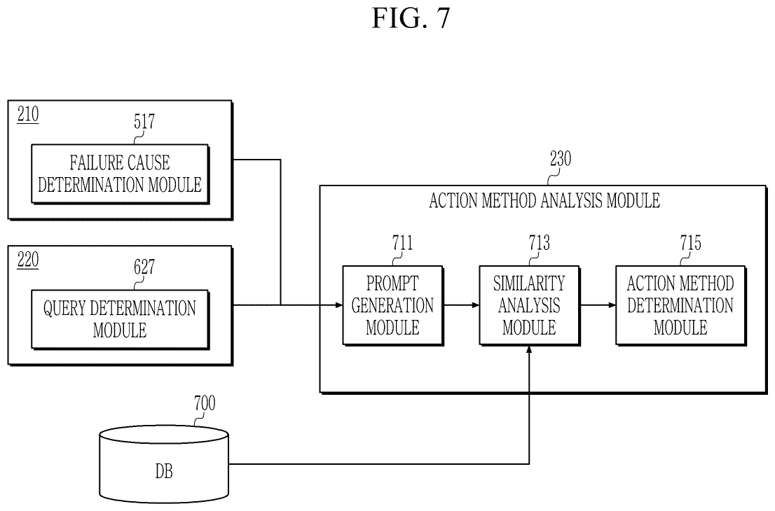

FIG. 7 is a diagram for explaining a method for analyzing an action method for resolving a cause of a failure of a facility by an electronic device according to one embodiment.

Referring to FIG. 7, the action method analysis module 230 according to one embodiment may include a prompt generation module 711, a similarity analysis module 713, and an action method determination module 715. In some embodiments, the action method analysis module 230 may omit at least one of the components described above or may additionally comprise other components.

According to one embodiment, the prompt generation module 711, the similarity analysis module 713, and the action method determination module 715 may be a detailed representation of the functions executed by the processor 110. The operations of the prompt generation module 711, the similarity analysis module 713, and the action method determination module 715 described below may be operations performed by the electronic device 100 by executing instructions stored in the memory 120 by the processor 110.

Regarding the operation of each component of the action method analysis module 230, a description of content that would be duplicative of the previously described details may be simplified or omitted with the understanding that the previous description is applicable.

According to one embodiment, the prompt generation module 711 may obtain the failure cause determined from the failure cause determination module 517. Additionally, the prompt generation module 711 may obtain a determined query from the query determination module 627.

According to one embodiment, the prompt generation module 711 may automatically generate prompts based on the cause of the failure and/or the query. According to one embodiment, the prompt generation module 711 may analyze the generated prompt.

According to one embodiment, the similarity analysis module 713 may obtain reference data from the database 700 based on the result of analyzing the prompt. According to one embodiment, the similarity analysis module 713 may analyze the similarity between the prompt and the reference data. For example, the electronic device 100 may calculate the cosine similarity between the prompt and the reference data. According to one embodiment, the similarity analysis module 713 may sort (or list) reference data in descending order of similarity based on the similarity calculation result.

According to one embodiment, the action method determination module 715 may determine an action method to resolve a failure of the facility based on reference data sorted in order of high similarity to generate guide data.

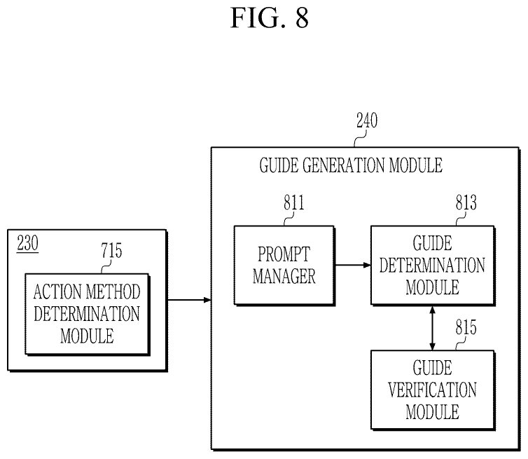

FIG. 8 is a diagram illustrating a method for an electronic device according to one embodiment of the present disclosure to generate guide data related to a failure of a facility.

Referring to FIG. 8, a guide generation module 240 according to one embodiment may include a prompt manager 811, a guide determination module 813, and a guide verification module 815. In some embodiments, the guide generation module 240 may omit at least one of the components described above or may additionally comprise other components.

According to one embodiment, the prompt manager 811, the guide determination module 813 and the guide verification module 815 may be a detailed representation of the functions executed by the processor 110. The operations of the prompt manager 811, the guide determination module 813, and the guide verification module 815 below may be operations performed by the electronic device 100 by executing instructions stored in the memory 120 by the processor 110.

Regarding the operation of each component of the guide generation module 240, a description of an operation or component that would be duplicative of the previously described details may be simplified or omitted with the understanding that the previous description is applicable.

According to one embodiment, the prompt manager 811 may select prompts to generate optimal guidance. For example, the prompt manager 811 may select a set of prompt candidates using a prompt lookup table. For example, the prompt manager 811 may select two or more prompts as prompt candidates. Here, the prompt lookup table may mean a data structure configured to quickly find a status description, action method, or query sentence corresponding to a keyword based on a keyword for a failure cause, facility status, or specific event.

Thereafter, the prompt manager 811 may determine the optimal prompt using the prompt classification model. Specific details regarding how the prompt manager 811 determines the optimal prompt are described below with reference to FIG. 9.

According to one embodiment, the guide determination module 813 may generate multimedia content based on the guide data received from the optimal prompt and action method determination module 715. For example, multimedia content may include at least one of video data, audio data, or still image data. At this time, the guide determination module 813 may analyze the guide data using an artificial intelligence model and automatically tag media content related to the analyzed content.

According to one embodiment, the guide verification module 815 may obtain multimedia content generated from the guide determination module 813. According to one embodiment, the guide verification module 815 may check (or verify) whether all data required for multimedia content is included. Specific details regarding the method by which the guide verification module 815 checks whether all data required for multimedia content is included are described below with reference to FIG. 10.

According to one embodiment, the guide determination module 813 may make a final determination on the multimedia content in response to the guide verification module 815 determining that all data required for the multimedia content is included.

FIG. 9 is a diagram illustrating a method for an electronic device to determine guide data according to one embodiment.

Referring to FIG. 9, a prompt manager 811 according to one embodiment may include a classification model 920. According to one embodiment, the classification model 920 included in the prompt manager 811 may represent a detailed representation of the function executed by the processor 110. The operations of the classification model 920 below may be operations performed by the electronic device 100 by executing instructions stored in the memory 120 by the processor 110.

According to one embodiment, the prompt manager 811 may select a set of prompt candidates 910 using a prompt lookup table. For example, the prompt manager 811 may select the first prompt 911, the second prompt 913, and the third prompt 915 as the prompt candidates 910.

According to one embodiment, the classification model 920 may classify a plurality of prompts included in the set of prompt candidates 910 into two or more groups. For example, the classification model 920 may classify the first prompt 911, the second prompt 913, and the third prompt 915 into the first group 930 and the second group 935. Here, the prompt classified into the first group 930 may be judged to have higher suitability than the prompt classified into the second group 935.

For example, the third prompt 915 may be classified into the first group 930, and the first prompt 911 and the second prompt 913 may be classified into the second group 935. In this case, the prompt manager 811 may determine the third prompt 915 as the optimal prompt.

FIG. 10 is a diagram illustrating a method for an electronic device according to one embodiment to determine whether necessary tagging information has been inserted into guide data. The operations described below may be performed by the electronic device 100 of FIG. 1. Specifically, the operations described below may be performed by the guide verification module 815 of FIG. 8.

The operations in FIG. 10 may be performed sequentially, but are not necessarily performed sequentially. For example, the order of the operations may be changed, and at least two operations may be performed in parallel. In some embodiments, some of the operations illustrated in FIG. 10 may be omitted, some operations may be combined, the order of some operations may be changed, or other operations may be added. A description of content that would be duplicative of the previously described details may be simplified or omitted with the understanding that the previous description is applicable.

Referring to FIG. 10, in operation 1001, an electronic device 100 according to one embodiment may obtain multimedia content with tagging information inserted.

In operation 1003, an electronic device 100 according to one embodiment may check whether all tagging information required for multimedia content has been inserted. For example, the electronic device 100 may determine whether all information such as video, still images, and audio related to the content has been inserted into the text-based guide data.

In operation 1005, the electronic device 100 according to one embodiment may request insertion of necessary tagging information based on determining that not all tagging information required for multimedia content has been inserted. Accordingly, it is possible to return to operation 1001 and obtain multimedia content with inserted tagging information.

In operation 1007, the electronic device 100 according to one embodiment may determine a guide based on determining that all tagging information required for multimedia content has been inserted. For example, the electronic device 100 may determine the multimedia content as a guide with all the necessary tagging information inserted.

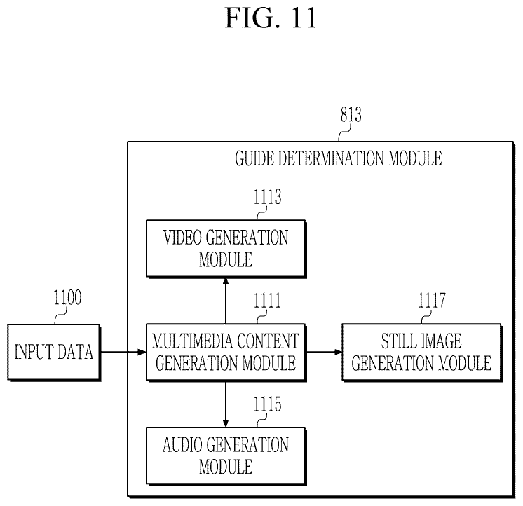

FIG. 11 is a diagram for explaining a method for an electronic device according to one embodiment of the present disclosure to generate multimedia content using guide data as input data.

Referring to FIG. 11, a guide determination module 813 according to one embodiment may include a multimedia content generation module 1111, a video generation module 1113, an audio generation module 1115, and a still image generation module 1117. In some embodiments, the guide determination module 813 may omit at least one of the components described above or may additionally comprise other components.

According to one embodiment, a multimedia content generation module 1111, a video generation module 1113, an audio generation module 1115, and a still image generation module 1117 may be segmented representations of functions executed by the processor 110. The operations of the multimedia content generation module 1111, the video generation module 1113, the audio generation module 1115, and the still image generation module 1117 described below may be operations performed by the electronic device 100 by executing instructions stored in the memory 120 by the processor 110.

Regarding the operation of each component of the guide determination module 813, the description of an operation or component that would be duplicative of the previous description may be simplified or omitted with the understanding that the previous description is applicable.

According to one embodiment, the multimedia content generation module 1111 may generate multimedia content based on input data 1100. Specifically, the multimedia content generation module 1111 may create multimedia content using guide data as input data 1100.

According to one embodiment, the multimedia content generation module 1111 may generate multimedia content including at least one of video data, audio data, or still image data based on at least some text included in input data 1100.

Specifically, the multimedia content generation module 1111 may insert tagging information corresponding to at least one of a video, audio, or still image into at least some text included in the input data 1100. For example, the multimedia content generation module 1111 may analyze input data 1100 composed of text and automatically tag media such as video, still images, and audio related to the content.

According to one embodiment, the video generation module 1113 may generate video data associated with the content in response to determining that the multimedia content generation module 1111 has tagged the video information.

According to one embodiment, the audio generation module 1115 may, in response to determining that the multimedia content generation module 1111 has tagged audio information, generate audio data associated with the content.

According to one embodiment, the still image generation module 1117 may generate still image data associated with the content in response to determining that the multimedia content generation module 1111 has tagged still image information.

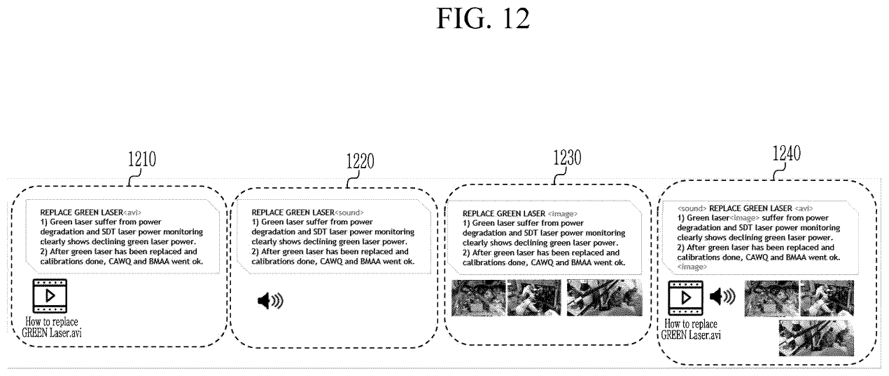

FIG. 12 is a diagram illustrating multimedia content generated by an electronic device according to some embodiments.

Referring to FIG. 12, an electronic device (e.g., the electronic device 100 of FIG. 1) according to one embodiment may insert tagging information corresponding to at least one of a video, audio, or still image into at least some text included in guide data.

For example, as illustrated in the first embodiment 1210, the electronic device 100 according to one embodiment may insert tagging information corresponding to a video into at least some of the text included in the guide data. Specifically, for example, multimedia content could include a video showing how to replace a particular component (e.g., a green laser) if the failure is the cause of the problem.

For example, as illustrated in the second embodiment 1220, the electronic device 100 according to one embodiment may insert tagging information corresponding to audio into at least some of the text included in the guide data. Specifically, for example, multimedia content could include instructions in audio form on how to replace a particular component (e.g., a green laser) if the component is causing a failure.

For example, as illustrated in the third embodiment 1230, the electronic device 100 according to one embodiment may insert tagging information corresponding to a still image into at least some of the text included in the guide data. Specifically, for example, multimedia content may include instructions in the form of a still image on how to replace a particular component (e.g., a green laser) if the failure is the cause of the failure. For example, a still image may be plural.

For example, as illustrated in the fourth embodiment 1240, the electronic device 100 according to one embodiment may insert tagging information corresponding to video, audio, and still images into at least some of the text included in the guide data. Specifically, for example, multimedia content may include, in the form of video, audio, and still images, instructions on how to replace a particular component (e.g., a green laser) if the failure is the cause.

However, this is not limited thereto, and according to some embodiments, the electronic device 100 may insert tagging information corresponding to a video, audio, still image, or a combination thereof into at least some of the text included in the guide data.

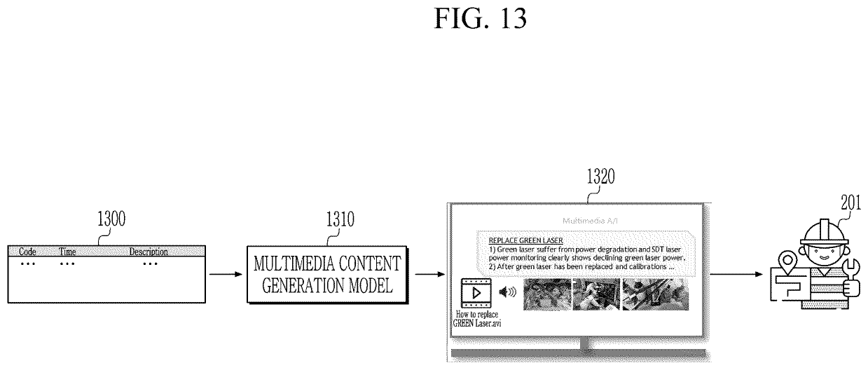

FIG. 13 is a diagram illustrating a method for an electronic device according to one embodiment of the present disclosure to generate and provide a guide for resolving a malfunction of a facility based on facility data. Here, a description of content that would be duplicative of the previous description may be simplified or omitted with the understanding that the previous description is applicable.

Referring to FIG. 13, an electronic device (e.g., electronic device 100 of FIG. 1) according to one embodiment may obtain facility data 1300 from facility (e.g., facility 200 of FIG. 2). According to one embodiment, the electronic device 100 may generate multimedia content using a multimedia content generation model 1310 based on facility data 1300. For example, multimedia content may include video, audio, images, or a combination thereof. According to one embodiment, the electronic device 100 may provide generated multimedia content to a user 201 through an output device 1320. For example, the output device 1320 may include a display, a speaker, and a user device. For example, the user device may include, but is not limited to, at least one of a smart phone, a smart watch, or a Bluetooth earphone. At least one user device may include various types of devices capable of communicating with the electronic device 100.

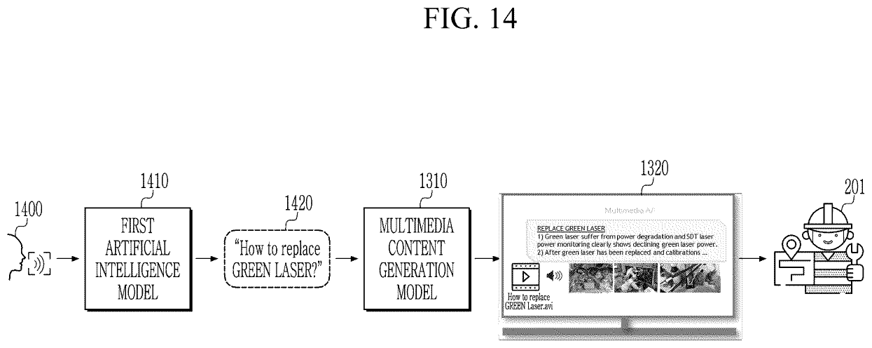

FIG. 14 is a diagram illustrating a method for an electronic device according to one embodiment of the present disclosure to generate and provide a guide for resolving a malfunction of a facility based on a user's voice. A description of content that would be duplicative of the previous description may be simplified or omitted with the understanding that the previous description is applicable.

Referring to FIG. 14, an electronic device (e.g., electronic device 100 of FIG. 1) according to one embodiment may obtain voice data 1400. For example, voice data 1400 may correspond to a user's utterances. According to one embodiment, the electronic device 100 may generate first text information 1420 (e.g., “How to replace Green Laser?”) using a first artificial intelligence model 1410 based on voice data 1400. According to one embodiment, the electronic device 100 may generate multimedia content using a multimedia content generation model 1310 based on first text information 1420. According to one embodiment, the electronic device 100 may provide generated multimedia content to a user 201 through an output device 1320. In other words, the electronic device 100 may provide continuous guidance to the user by identifying the user's intention (or state) based on voice data 1400 and providing the next action guide.

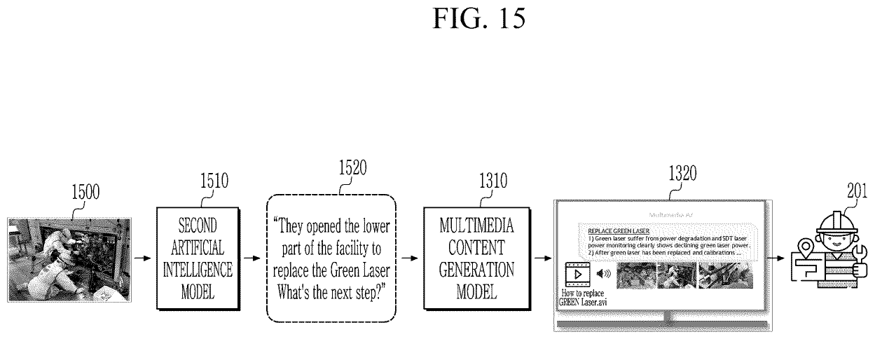

FIG. 15 is a diagram illustrating a method for an electronic device according to one embodiment of the present disclosure to generate and provide a guide for resolving facility failures based on user movements. Here, any content that overlaps with what has been previously stated may be simplified or omitted.

Referring to FIG. 15, an electronic device (e.g., electronic device 100 of FIG. 1) according to one embodiment may obtain image data 1500. For example, the image data 1500 may include a video or still image captured by the user. According to one embodiment, the electronic device 100 may generate second text information 1520 (e.g., “They opened the lower part of the facility to replace the Green Laser. What's the next step?”) using the second artificial intelligence model 1510 based on the image data 1500. According to one embodiment, the electronic device 100 may generate multimedia content using a multimedia content generation model 1310 based on second text information 1520. According to one embodiment, the electronic device 100 may provide generated multimedia content to a user 201 through an output device 1320. For example, the electronic device 100 may provide continuous guidance to the user by identifying the user's intention (or state) based on image data 1500 and providing the next action guide.

As described above, the electronic device 100 according to the present disclosure may improve the efficiency of information transmission by generating a method of action for facility failure and an action guide for engineers in the form of multimedia content.

For example, the electronic device 100 according to the present disclosure may provide a user with a combination of various contents such as text, images, audio, and video, thereby allowing the user to intuitively and easily understand complex information.

The electronic device 100 according to the present disclosure may improve user experience by generating a method of action for facility failure and an action guide for engineers in the form of multimedia content.

For example, the electronic device 100 according to the present disclosure may improve user immersion compared to a simple text-based guide by providing integrated visual and auditory elements.

An electronic device 100 according to the present disclosure may provide step-by-step audio or visualization of complex procedures such as fault diagnosis, maintenance, and action methods by utilizing multimedia content.

The electronic device 100 according to the present disclosure may provide a guide as customized content such as text-centered, voice-centered, or image-centered, depending on the user's skill level or preference, by utilizing multimedia content.

The electronic device 100 according to the present disclosure may improve productivity and work efficiency by reducing user work errors and enabling quick problem resolution through multimedia-based intuitive and clear guides.

Multimedia content generated by an electronic device 100 according to the present disclosure is compatible with various platforms such as smartphones, tablets, and AR/VR devices, and may provide a guide that may be accessed anytime, anywhere.

The multimedia-based guide generated by the electronic device 100 according to the present disclosure may easily support multiple languages through voice and subtitles, and thus may effectively provide the guide to global users.

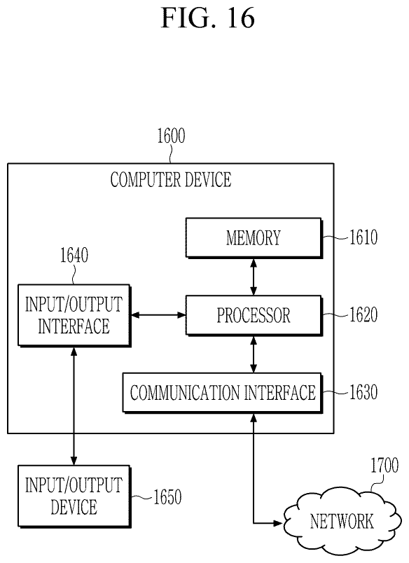

FIG. 16 is a diagram illustrating an example of a computer device implementing an electronic device according to one embodiment. The electronic device 100 of FIG. 1 may be implemented by the computer device 1600 illustrated in FIG. 16.

Referring to FIG. 16, a computer device 1600 may include a memory 1610, a processor 1620, a communication interface 1630, and an input/output interface 1640.

Memory 1610 is a computer-readable storage medium and may include random access memory (RAM), read only memory (ROM), and a permanent mass storage device such as a disk drive. Additionally, an operating system and at least one program code may be stored in the memory 1610. These software components may be loaded into the memory 1610 from a computer-readable storage medium separate from the memory 1610. Such separate computer-readable recording media may include computer-readable recording media such as a hard disk, flash memory, an optical disk, an external hard disk, etc. Additionally, these software components may be loaded into memory 1610 via a communication interface 1630.

The processor 1620 may be configured to process instructions of a computer program by performing basic arithmetic, logic, and input/output operations. The instructions may be provided to the processor 1620 by memory 1610 or a communication interface 1630.

The communication interface 1630 may provide a function for the computer device 1600 to communicate with other devices via a network 1700. The communication method is not limited, and may include not only a communication method utilizing a communication network (e.g., a mobile communication network, wired Internet, wireless Internet, or broadcasting network) that the network 1700 may include, but also short-range wireless communication between devices. For example, the network 1700 may include any one or more of networks such as a personal area network (PAN), a local area network (LAN), a campus area network (CAN), a metropolitan area network (MAN), a wide area network (WAN), a broadband network (BBN), and the Internet. Additionally, the network 1700 may include any one or more of network topologies including, but not limited to, a bus network, a star network, a ring network, a mesh network, a star-bus network, a tree, or a hierarchical network.

The input/output interface 1640 may serve as an interface that may transmit instructions or data input from a user or an input/output device 1650 to other component(s) of the computer device 1600. Additionally, the input/output interface 1640 may output instructions or data received from other components(s) of the computer device 1600 to a user or an input/output device 1650. For example, the input/output device 1650 may include an input device such as a microphone, a keyboard, or a mouse, and the output device may include an output device such as a display or a speaker.

The embodiments described above may be implemented in the form of a computer program that may be executed through various components on a computer, and such a program may be recorded on a computer-readable medium. At this time, the medium may include magnetic media such as hard disks, floppy disks, and magnetic tapes, optical recording media such as CD-ROMs and DVDs, magneto-optical media such as floptical disks, and hardware devices specifically configured to store and execute program instructions, such as ROMs, RAMs, flash memories, etc.

Unless the order of steps constituting a method according to an embodiment is explicitly stated or contradicted, the steps may be performed in any suitable order. The present disclosure is not necessarily limited to the order in which the above steps are described.

Any use of examples or exemplary language in this specification is intended merely to illustrate the disclosure in more detail and is not intended to limit the scope of the disclosure. Additionally, one of ordinary skill in the art will recognize that various modifications, combinations, and changes may be made within the scope of the patent claims or their equivalents.

Although the embodiments of the present disclosure have been described in detail above, the scope of the inventive concept is not limited thereto, and various modifications and improvements made by those skilled in the art of the inventive concept described in the present disclosure fall within the scope of the inventive concept as defined in the following claims.

What is claimed is:

1. An electronic device comprising:
a communication circuit;
a memory; and
a processor;
wherein the memory stores instructions that, when executed by the processor, cause the electronic device to:
acquire facility data from a facility via the communication circuit;
analyze a cause of failure of the facility based on the facility data;
generate guide data identifying actions for resolving the failure of the facility based on an analysis result of the cause of failure;
generate multimedia content related to the actions for resolving the failure using the guide data as input data; and
output the multimedia content.

2. The electronic device of claim 1,
wherein the facility data includes facility text log data and facility time-series data, and
wherein the instructions, when executed by the processor, cause the electronic device to analyze the cause of failure by integrating the facility text log data and the facility time-series data.

3. The electronic device of claim 2,
wherein the instructions, when executed by the processor, cause the electronic device to:
generate a query related to the failure of the facility based on the facility text log data, and
generate the guide data for resolving the failure of the facility based in part on the query related to the failure of the facility.

4. The electronic device of claim 3,
wherein the instructions, when executed by the processor, cause the electronic device to:
generate prompt data corresponding to at least one of the facility data and the generated query;
analyze a similarity between the prompt data and reference data pre-stored in the memory to generate a similarity analysis result; and
generate the guide data based on the similarity analysis result.

5. The electronic device of claim 4,
wherein the instructions, when executed by the processor, cause the electronic device to:
extract a first feature vector from the prompt data;
extract a second feature vector from the reference data pre-stored in the memory; and
determine a similarity between the first feature vector and the second feature vector to analyze the similarity.

6. The electronic device of claim 1,
wherein the guide data includes text, and
wherein the instructions, when executed by the processor, cause the electronic device to generate the multimedia content including at least one of video data, audio data, and still image data based on at least a portion of the text included in the guide data.

7. The electronic device of claim 6,
wherein the instructions, when executed by the processor, cause the electronic device to:
insert tagging information corresponding to at least one of video data, audio data, or still image data into the text included in the guide data; and
generate the multimedia content including video data, audio data, or still image data based on the tagging information.

8. The electronic device of claim 6, further comprising a display,
wherein the instructions, when executed by the processor, cause the electronic device to:
determine that the multimedia content includes at least one of the video data and the still image data, and
output the multimedia content via the display based on the determination that the multimedia content includes video data or still image data.

9. The electronic device of claim 6, further comprising a speaker,
wherein the instructions, when executed by the processor, cause the electronic device to:
determine that the multimedia content includes audio data; and
output the audio data via the speaker.

10. An electronic device comprising:
a memory, and
a processor,
wherein the memory stores instructions that, when executed by the processor, cause the electronic device to:
acquire user provided data related to a failure of a facility;
generate text information corresponding to the user provided data;
generate guide data identifying actions for resolving the failure of the facility based on the text information;
generate multimedia content related to the actions for resolving the failure using the guide data as input data; and
output the multimedia content.

11. The electronic device of claim 10, further comprising a microphone,
wherein the user provided data comprises voice data, and the instructions, when executed by the processor, cause the electronic device to:
acquire the voice data corresponding to user speech via the microphone, and
generate the text information corresponding to the voice data.

12. The electronic device of claim 10, further comprising a camera,
wherein the user provided data comprises image data and the instructions, when executed by the processor, cause the electronic device to:
acquire the image data corresponding to user movements via the camera; and
generate the text information corresponding to the image data.

13. The electronic device of claim 10,
wherein the instructions, when executed by the processor, cause the electronic device to:
generate prompt data corresponding to the user provided data;
analyze a similarity between the prompt data and reference data pre-stored in the memory to generate a similarity analysis result; and
generate the guide data based on the similarity analysis result.

14. The electronic device of claim 13,
wherein the instructions, when executed by the processor, cause the electronic device to:
extract a first feature vector from the prompt data;
extract a second feature vector from the reference data pre-stored in the memory; and
analyze the similarity between the first feature vector and the second feature vector to analyze the similarity.

15. The electronic device of claim 10,
wherein the guide data includes text, and
wherein the instructions, when executed by the processor, cause the electronic device to generate the multimedia content including at least one of video data, audio data, and still image data based on at least a portion of the text included in the guide data.

16. The electronic device of claim 15,
wherein the instructions, when executed by the processor, cause the electronic device to:
insert tagging information corresponding to at least one of video data, audio data, and image data into at least a part of the text included in the guide data; and
generate the multimedia content including the video data, the audio data, or the still image data based on the tagging information.

17. The electronic device of claim 15, further comprising a display,
wherein the instructions, when executed by the processor, cause the electronic device to:
determine that the multimedia content includes at least one of the video data and the still image data; and
output the at least one of the video data and the still image data via the display.

18. The electronic device of claim 15, further comprising a speaker,
wherein the instructions, when executed by the processor, cause the electronic device to:
determine that the multimedia content includes the audio data; and
output the audio data via the speaker.

19. An electronic device comprising:
a communication circuit,
a memory storing a first artificial intelligence (AI) model trained to generate text corresponding to input data and a second AI model trained to insert tagging information corresponding to a media type into the input data, and
a processor,
wherein the memory stores instructions that, when executed by the processor, cause the electronic device to:
acquire facility data related to a failure of a facility via the communication circuit
acquire user submitted data related to the failure of the facility,
generate text information corresponding to the facility data or the user submitted data using the first AI model;
generate guide data describing a procedure resolving the failure of the facility based on the text information;
insert tagging information corresponding to the media type into the guide data using the second AI model; and
generate multimedia content related to the procedure resolving the failure based on the inserted tagging information.

20. The electronic device of claim 19,
wherein the media type includes at least one of video, audio, and still image.
